(19) United States
(12) Patent Application Publication
(10) Pub. No.: US 2007/0065346 A1
(43) Pub. Date: Mar. 22, 2007

(54) Micro-fluidic device with neutralization and neutralization methods

(76) Inventors: Lauren Renee Henry, Dallas, OR (US); Philip Harding, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/230,157

(22) Filed: Sep. 19, 2005

(51) Int. Cl. B01L 3/00

(52) U.S. Cl. 422/100

(57) ABSTRACT

A neutralizing agent is directed from a first reservoir formed in a substrate of a micro-fluidic device through a second reservoir formed in the substrate after contents of the second reservoir are dispensed.

### BACKGROUND

Fluid handling systems sometimes reside on disposable substrates, e.g., compact discs, cards, or the like. For some applications, these fluid handling systems are used to obtain clinical assays of blood, saliva, urine, and other biological fluids, e.g., for measuring analytes, such as cholesterol, cortisol, etc. Such systems are sometimes used in at-home testing regimens. However, such at-home testing is likely to increase the amount of biohazard waste entering the common household waste stream that could increase the risk of exposure of pathogens to household members and sanitation workers.

### DESCRIPTION OF THE DRAWINGS

FIG. 1 illustrates an embodiment of an analyzer, according to an embodiment of the invention.

FIG. 2 illustrates an embodiment of a micro-fluidic device, according to another embodiment of the invention.

FIG. 3 is an enlarged view of an embodiment of a micro-fluidic handling system, according to another embodiment of the invention.

FIG. 4 is an enlarged view of an embodiment of a micro-fluidic handling system, according to another embodiment of the invention.

FIG. 5 illustrates an embodiment of a micro-fluidic device, according to another embodiment of the invention.

FIG. 6 illustrates an embodiment of a micro-fluidic device, according to another embodiment of the invention.

### DETAILED DESCRIPTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that process, electrical, or mechanical changes may be made without departing from the scope of the claimed subject matter. The following detailed description is, therefore, not to be taken in a limiting sense, and the scope of the claimed subject matter is defined only by the appended claims and equivalents thereof.

One embodiment of the invention provides a micro-fluidic device having a substrate, such as a rotatable disc, a card, or the like, with a first reservoir formed on the substrate for receiving and containing a liquid, such as a liquid sample or reagent and a second reservoir formed on the substrate containing a neutralizing agent. The second reservoir is fluidly coupled to the first reservoir, e.g., by a micro-fluidic channel formed in the substrate. In operation, the neutralizing agent is directed from the second reservoir and through the first reservoir after the liquid has been dispensed from the first reservoir. For one embodiment, the neutralizing agent neutralizes microorganisms, e.g., antibodies, or chemical agents, e.g., neutralizes the pH, or both. For another embodiment, the neutralizing agent is a disinfectant, such as aqueous sodium hypochlorite that disinfects biohazard wasets.

For another embodiment, the neutralizing agent reservoir is fluidly coupled to a reagent reservoir containing a reagent and a sample reservoir, e.g., by a micro-fluidic channel formed in the substrate. For yet another embodiment, the neutralizing agent is directed from the neutralizing agent reservoir and through the sample reservoir after a liquid sample has been dispensed from the sample reservoir and through the reagent reservoir after the reagent is dispensed. For other embodiments, the neutralizing agent empties into a waste reservoir. For some embodiments, neutralizing agent may be caused to flow by centrifugal forces induced by rotation of a disc containing the micro-fluidic system, or a pump, manual squeezing of a bulb, etc. Various embodiments are illustrated below by non-limiting examples.

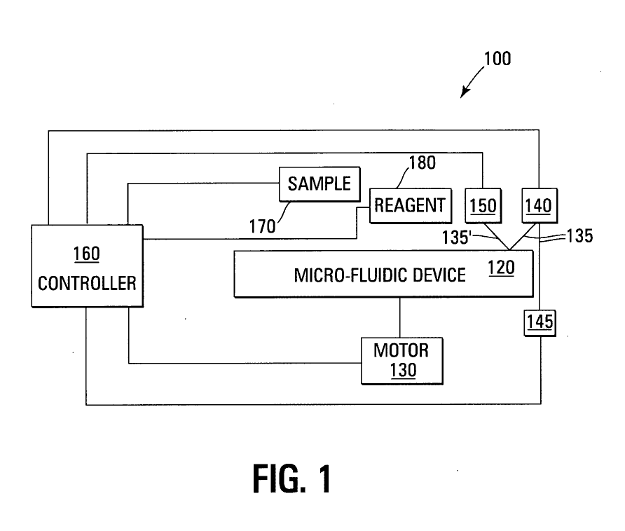

FIG. 1 illustrates an analyzer 100, according to an embodiment. For one embodiment, analyzer 100 receives and activates a micro-fluidic device 120 for performing assays of blood, saliva, and other bodily fluids for determining analytes, such as cholesterol, cortisol, and others. For one embodiment, micro-fluidic device 120 is formed on a rotatable medium, such as a disc that is rotated by a motor 130. For another embodiment, micro-fluidic device 120 is formed on a card. For one embodiment, analyzer 100 includes a sample station 170 and a reagent station 180 that may add samples and reagents to sample and reagent reservoirs of micro-fluidic device 120. For another embodiment, the sample and reagents may be disposed on the micro-fluidic device 120 prior to insertion into the analyzer, e.g. during manufacture of the micro-fluidic device. For one embodiment, a light beam 135 from a light source 140 illuminates a reacted sample contained in micro-fluidic handling system 120, and a detector 145 detects light transmission or fluorescence from the sample, or a detector 150 detects a reflection of light beam 135′ from the sample for analysis. A controller 160 controls the operation of analyzer 100.

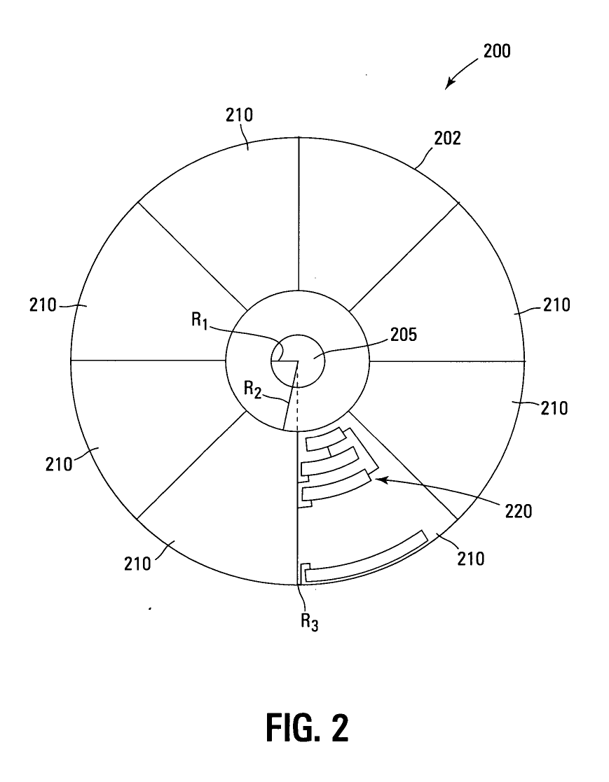

FIG. 2 illustrates an example of a micro-fluidic device 200 formed on a substrate 202 in the shape of a rotatable disc, according to an embodiment. For one embodiment, micro-fluidic device 200 includes a hole 205 of radius R₁ for receiving a spindle for rotating micro-fluidic device 200, such as motor 130 of FIG. 1. For another embodiment, micro-fluidic device 200 includes a plurality of angular sections 210, with one or more of the angular sections containing a micro-fluidic handling system 220. Note that the one or more micro-fluidic handling systems are located between a hub region having a radius R₂ and an outer radius R₃ of the disc. For a further embodiment, each micro-fluidic fluid handling system 220 is configured to perform assays of blood, saliva, and other bodily fluids for determining analytes, such as cholesterol, cortisol, and others.

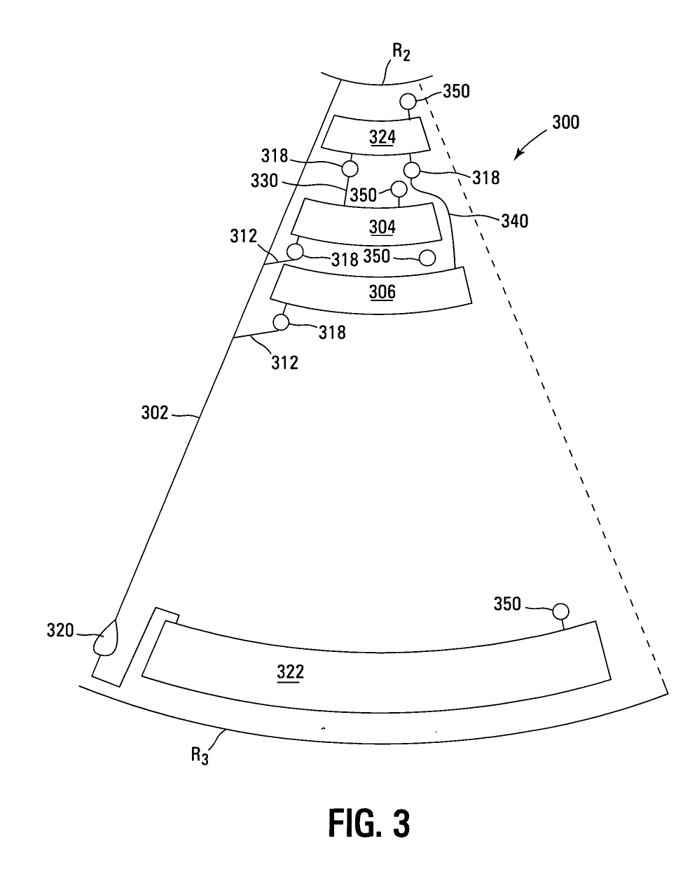

FIG. 3 illustrates a micro-fluidic handling system 300 that may be located in an angular section 210 of micro-fluidic device 200 (FIG. 2), according to another embodiment. Micro-fluidic handling system 300 includes a common drain line 302, e.g., a micro-fluidic channel. Common drain line 302, for one embodiment, is fluidly coupled to each of reservoirs 304 and 306 by an individual drain line 312, e.g., a micro-fluidic channel that may include a micro-fluidic valve 318, e.g., a so called capillary valve which harnesses the capillary forces at an abrupt channel expansion to control fluid movement. Common drain line 302 also opens into a reaction chamber 320 having an outlet fluidly coupled to a reservoir 322 that for one embodiment acts as a waste reservoir for micro-fluidic handling system 300. For one embodiment, the reaction chamber may serve as both a chamber for reaction and solution analysis, e.g. as a cuvette. For one embodiment, a reservoir 324 is fluidly coupled to reservoirs 304 and 306 respectively by micro-fluidic channels 330 and 340 that may each include a micro-fluidic valve 318. For other embodiments, each of reservoirs 304, 306, 322, and 324, has an individual air intake (or vent) 350 that might include a micro-fluidic valve similar to micro-fluidic valves 318.

For another embodiment, reservoir 324 contains a neutralizing agent that when released flushes and neutralizes (or disinfects) reservoirs 304 and 306 after their contents, e.g., samples and reagents, have been dispensed. The neutralizing agent flows from reservoirs 304 and 306 into common drain line 302 and flushes and neutralizes common drain line 302. The neutralizing agent then flushes and neutralizes reaction chamber 320 and flows into reservoir 322 for neutralizing reservoir 322. For one embodiment, the contents of reservoirs 304 and 306, as well as the neutralizing agent contained in reservoir 324, are dispensed by centrifugal forces due to the rotation of the disc containing micro-fluidic handling system 300.

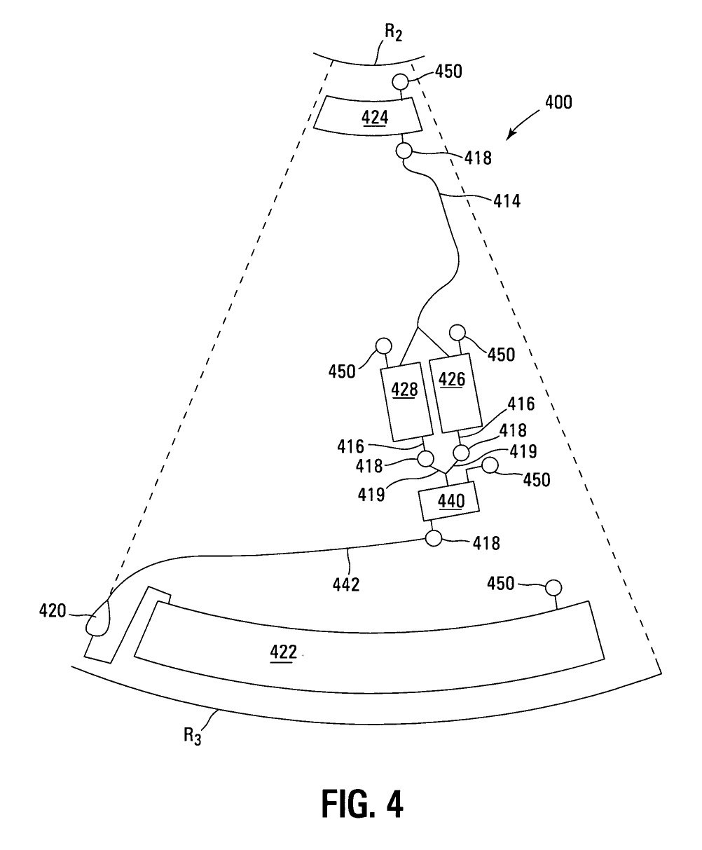

FIG. 4 illustrates a micro-fluidic handling system 400 that may be located in an angular section 210 of micro-fluidic device 200 (FIG. 2) or combined with micro-fluidic handling system 300 (FIG. 3), according to another embodiment. For one embodiment, a reservoir 424 is fluidly coupled to an inlet of each of reservoirs 426 and 428, e.g., an outlet of reservoir 424 is connected to a micro-fluidic valve 418 that is connected to an inlet of reservoir 426 and an inlet of reservoir 428 by a micro-fluidic channel 414. For some embodiments reservoir 428 is optional. An outlet of each of reservoirs 426 and 428 is fluidly coupled to an inlet of a reservoir 440, e.g., the outlet of reservoir 426 is coupled to a micro-fluidic valve 418 by a micro-fluidic channel 416, the outlet of reservoir 428 is coupled to another micro-fluidic valve 418 by a micro-fluidic channel 416, and both micro-fluidic valves 418 are coupled to the inlet of reservoir 440 by a micro-fluidic channel 419. For some embodiments reservoir 440 is optional. For another embodiment, an outlet of reservoir 440 is fluidly coupled to a reaction chamber 420 by a micro-fluidic valve 418 and a micro-fluidic channel 442. For other embodiments, each of reservoirs 422, 424, 426, 428, and 440 has an individual air intake (or vent) 450 that might include a micro-fluidic valve similar to micro-fluidic valves 418. For one embodiment, the air intakes may be coupled or manifolded to a common air intake (not shown).

For the exemplary rotatable disc platforms of FIGS. 3 and 4, fluid contained in each of reservoirs 324, 304, and 306 of FIG. 3 and each of reservoirs 424, 426, 428, and 440 of FIG. 4 will flow therefrom upon opening of a micro-fluidic valve due to an imbalance between a centrifugal force on the fluid contained in each reservoir and opposing forces, such as viscous and capillary forces. Centrifugal force acts to cause the fluid to flow outward toward the outer radius R₃, with the flow rate depending on factors including radial location of a particular reservoir, the density of the fluid within the reservoir, and the rotational velocity of the micro-fluidic device, such as micro-fluidic device 200, containing the micro-fluidic handling system, such as micro-fluidic handling system 300 or micro-fluidic handling system 400 or both, as is known in the art.

For one embodiment, micro-fluidic fluid handling systems 300 and 400 are configured to perform assays of biological fluids, such as blood, saliva, urine, etc., for determining analytes, such as cholesterol, cortisol, etc. For example, a sample, e.g., a biological fluid, may be disposed in reservoir 426 and a reagent may be disposed in reservoir 428. The micro-fluidic fluid handling system 300 or 400 is then inserted into an analyzer, such as analyzer 100 of FIG. 1, that rotates micro-fluidic fluid handling system at various rotational velocities.

For another embodiment, the sample may be placed in sample collection station 170 of analyzer 100 (FIG. 1), and analyzer 100 dispenses the sample into reservoir 426 (FIG. 4). For one embodiment, analyzer 100 may contain various reagents at reagent station 180 (FIG. 1), one of which is selectively dispensed in reservoir 428 (FIG. 4) based on a user input. For another embodiment, the reagent may be pre-dispensed in reservoir 428, e.g., during a manufacturing process, thereby establishing the micro-fluidic handling system 400 for performing a particular assay. A detectable reagent, such as a chromophore, is either dispensed into reservoir 304 (FIG. 3) by analyzer 100 or is pre-dispensed in reservoir 304, and washing substances, such as water or saline solution, may be either dispensed by the analyzer or pre-dispensed into reservoir 306 (FIG. 3). For one embodiment, a neutralizing agent is pre-dispensed in reservoir 424.

For another embodiment, when a substance is pre-dispensed into a reservoir, e.g., during a manufacturing process, the outlet or inlet of that reservoir, or both, may be temporarily sealed, such as by a removable plug, e.g., of a thermally removable substance, such as a wax, that can be unsealed by analyzer 100. For example, analyzer 100 may direct light onto the seal for thermally removing the seal. Other examples of temporary seals include a film that may be pierced, a peel-back, etc.

In operation, according to another embodiment, micro-fluidic device 200 (FIG. 2) is rotated at a rotational velocity sufficient to cause the sample and the reagent to flow respectively from reservoirs 426 and 428 into reservoir 440 that acts as a mixing reservoir (FIG. 4). Micro-fluidic device 200 is then rotated at a rotational velocity sufficient to cause the mixed sample and reagent to flow from reservoir 440 to reaction chamber 420. For another embodiment, reservoirs 428 and 440 are optional and may be omitted so that the sample flows directly into reaction chamber 420. Analyzer 100 (FIG. 1) then may remove a seal from reservoir 424 and subsequently rotate micro-fluidic device 200 at a rotational velocity sufficient to cause neutralizing agent to flow from reservoir 424 through reservoirs 426, 428, and 440, through reaction chamber 420, and into reservoir 422 for neutralizing reservoirs 426, 428, and 440, reaction chamber 420, and reservoir 422. For the embodiment where reservoirs 428 and 440 are omitted, the neutralizing agent flows through reservoir 426, through reaction chamber 420, and into reservoir 422.

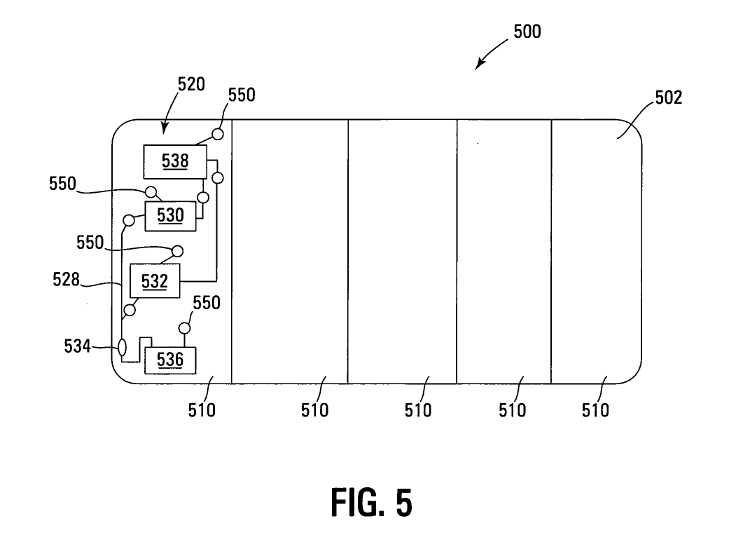

FIG. 5 illustrates a micro-fluidic device 500 formed on a substrate 502 in the shape of a card, such as a credit or business card, according to another embodiment. For another embodiment, micro-fluidic device 500 includes a plurality of sections 510, with one or more of sections 510 containing a micro-fluidic handling system 520. For a further embodiment, each micro-fluidic fluid handling system 520 is configured to perform assays of blood, saliva, and other bodily fluids for determining analytes, such as cholesterol, cortisol, and others.

For one embodiment, a micro-fluidic handling system 520 includes a common drain line 528, e.g., a micro-fluidic channel. Common drain line 528, for one embodiment, is fluidly coupled to each of reservoirs 530 and 532 by an individual drain line, e.g., a micro-fluidic channel that may include a micro-fluidic valve, as described above. Common drain line 528 also opens into a reaction chamber (or cuvette) 534, having an outlet fluidly coupled to a reservoir 536 that for one embodiment acts as a waste reservoir for micro-fluidic handling system 520.

For one embodiment, a reservoir 538 is fluidly coupled to an inlet of each of reservoirs 530 and 532, e.g., by a micro-fluidic channel. For other embodiments, each of reservoirs 530, 532, 536, and 538 may have an individual port 550 that is connectable to a controllable pressure source, e.g., when micro-fluidic device 500 is inserted into an analyzer, such as analyzer 100 of FIG. 1. This enables each of reservoirs 530, 532, 536, and 538 to be selectively pressurized for selectively expelling any fluid contained in that reservoir.

For another embodiment, reservoir 538 contains a neutralizing agent that when released flushes and neutralizes reservoirs 530 and 532 after their contents, e.g., reagents, have been dispensed. The neutralizing agent flows from reservoirs 530 and 532 into common drain line 528 and flushes and neutralizes common drain line 528. The neutralizing agent then flushes and neutralizes reaction chamber 534 and flows into reservoir 536 for neutralizing reservoir 536.

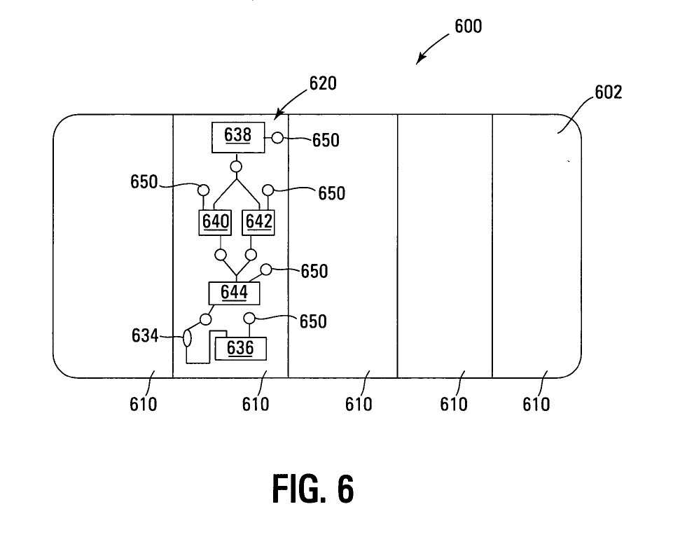

FIG. 6 illustrates a micro-fluidic device 600 formed on a substrate 602 in the shape of a card, such as a credit or business card, according to another embodiment. For one embodiment, micro-fluidic device 600 includes a plurality of sections 610, with one or more of sections 610 containing a micro-fluidic handling system 620. For a further embodiment, each micro-fluidic fluid handling system 620 is configured to perform assays of blood, saliva, and other bodily fluids for determining analytes, such as cholesterol, cortisol, and others. A reservoir 638 is fluidly coupled to reservoirs 640 and 642, e.g., by a micro-fluidic channel that may include a micro-fluidic valve, as described above. Reservoirs 640 and 642 are fluidly coupled to a reservoir 644, e.g., by micro-fluidic channels that may include micro-fluidic valves. Reservoir 644 is fluidly coupled to a reaction chamber 634, e.g., by a micro-fluidic channel that may include micro-fluidic valve. Reaction chamber 634 is fluidly coupled to a reservoir 636 that for one embodiment acts as a waste reservoir for micro-fluidic handling system 620. For other embodiments, each of reservoirs 638, 640, 642, 644, and 636 may have an individual port 650 that is connectable to a controllable pressure source, e.g., when micro-fluidic device 600 is inserted into an analyzer, such as analyzer 100 of FIG. 1. This enables each of reservoirs 638, 640, 642, 644, and 636 to be selectively pressurized for selectively expelling any fluid contained in that reservoir.

For one embodiment, a sample, e.g., a biological fluid, is disposed in reservoir 640 and a reagent is disposed in reservoir 642. Micro-fluidic device 600 is then inserted into an analyzer, such as analyzer 100 of FIG. 1, where it remains stationary.

For another embodiment, the sample may be placed in analyzer 100, and analyzer 100 dispenses the sample into reservoir 640. For one embodiment, analyzer 100 may selectively dispense a reagent in reservoir 642 based on a user input. For another embodiment, the reagent may be pre-dispensed in reservoir 642, e.g., during a manufacturing process, thereby establishing micro-fluidic handling system 620 for performing a particular assay. For one embodiment, a neutralizing agent is pre-dispensed in reservoir 638.

For another embodiment, when a substance is pre-dispensed in a reservoir, e.g., during a manufacturing process, an inlet or outlet of the reservoir, or both, may be sealed, such as by a removable plug, e.g., of a thermally removable substance, such as a wax, that can be unsealed by analyzer 100. For example, analyzer 100 may direct light onto the seal for thermally removing the seal. Other examples of suitable temporary reservoir seals include a film that may be pierced by an object or fluid pressure, a peel-back, etc.

Reservoirs 640 and 642 are selectively pressurized to cause the sample and the reagent to flow into reservoir 644 that acts as a mixing reservoir. Reservoir 644 is then selectively pressurized to cause the mixed sample and reagent to flow to reaction chamber 634. For another embodiment, reservoirs 642 and 644 are optional and may be omitted so that the sample flows directly into reaction chamber 634. The reacted sample is detected optically by analyzer 100 (FIG. 1), as described above. Analyzer 100 may remove a seal from reservoir 638 and subsequently selectively pressurize reservoir 638 to cause neutralizing agent to flow from reservoir 638 through reservoirs 640, 642, and 644, through reaction chamber 634, and into reservoir 636 for neutralizing reservoirs 640, 642, and 644, reaction chamber 634, and reservoir 636. For the embodiment, where reservoirs 642 and 644 are omitted, the neutralizing agent flows through reservoir 640, through reaction chamber 634, and into reservoir 636.

For one embodiment, substrate 202 (FIG. 2), substrate 502 (FIG. 5), substrate 602 (FIG. 6) may be of plastic or the like. The respective reservoirs and micro-fluidic channels may be formed on the substrates using an end mill, a molding process, a stamping process chemical etching, laser ablation, etc. A film or the like may be formed over the reservoirs and micro-channels for closing them.

For further embodiments, micro-fluidic devices 500 (FIG. 5) and 600 (FIG. 5) may be configured as lateral-flow devices. For one embodiment, this may include a neutralizing agent and/or disinfectant in one or more reservoirs fluidly coupled to one or more of the reservoirs shown in FIGS. 5 and 6. Generally, the one or more reservoirs containing the neutralizing agent and/or disinfectant will include a microvalve that may be selectively activated, e.g., by a user, to cause the neutralizing and/or disinfectant fluids to laterally flow through the micro-fluidic device.

### CONCLUSION

Although specific embodiments have been illustrated and described herein it is manifestly intended that the scope of the claimed subject matter be limited only by the following claims and equivalents thereof.

What is claimed is:

1. A micro-fluidic device comprising:
a substrate;
a first reservoir formed on the substrate for receiving and containing a liquid; and
a second reservoir formed on the substrate and containing a neutralizing agent, wherein the second reservoir is fluidly coupled to the first reservoir.

2. The micro-fluidic device of claim 1, wherein a micro-fluidic channel formed on the substrate fluidly couples the first and second reservoirs.

3. The micro-fluidic device of claim 1, wherein the substrate is a rotatable medium.

4. The micro-fluidic device of claim 1, wherein the substrate is a card.

5. The micro-fluidic device of claim 4, wherein the card is a lateral flow device.

6. The micro-fluidic device of claim 1, wherein the micro-fluidic device is configured for performing chemical assays.

7. The micro-fluidic device of claim 1, wherein the liquid is selected form the group consisting of a sample, a reagent, and a biological fluid.

8. The micro-fluidic device of claim 1 further comprises a reaction chamber fluidly coupled to the first and second reservoirs.

9. The micro-fluidic device of claim 8 further comprises a third reservoir fluidly coupled to the first reservoir and the reaction chamber.

10. The micro-fluidic device of claim 8 further comprises a third reservoir fluidly coupled to the reaction chamber and containing a detectable substance.

11. The micro-fluidic device of claim 1 further comprises:
a third reservoir fluidly coupled to the first reservoir;
a fourth reservoir fluidly coupled to the first and third reservoirs;
a reaction fluidly coupled to the fourth reservoir; and
a fifth reservoir fluidly coupled to the reaction chamber.

12. A rotatable medium comprising:
one or more micro-fluidic fluid handling systems, wherein each micro-fluidic fluid handling system comprises:
a first reservoir for receiving and containing a liquid; and
a second reservoir containing a neutralizing agent and fluidly coupled to the first reservoir;
wherein the first reservoir is located so that the liquid is dispensed therefrom at a first rotational velocity of the rotatable medium and the second reservoir is located so that the neutralizing agent is dispensed at a second rotational velocity of the rotatable medium different from the first rotational velocity.

13. The rotatable medium of claim 12 further comprises a reaction chamber fluidly coupled to the first reservoir and to the second reservoir through the first reservoir.

14. The rotatable medium of claim 13 further comprises a third reservoir containing a reagent and fluidly coupled to the reaction chamber, wherein the third reservoir is located so that the reagent is dispensed at a third rotational velocity of the rotatable medium different from the first and second rotational velocities.

15. The rotatable medium of claim 14, wherein the third reservoir is further fluidly coupled to the second reservoir.

16. The rotatable medium of claim 12, wherein the liquid is selected form the group consisting of a sample, a reagent, and a biological fluid.

17. A card comprising:
one or more micro-fluidic fluid handling systems, wherein each micro-fluidic fluid handling system comprises:
a first reservoir for receiving and containing a liquid; and
a second reservoir containing a neutralizing agent and fluidly coupled to the first reservoir;
wherein the first reservoir and second reservoirs are connectable to a pressure source for selectively dispensing the liquid from the first reservoir and the neutralizing agent from the second reservoir, respectively, at different times.

18. The card of claim 17 further comprises a reaction chamber fluidly coupled to first reservoir and to the second reservoir through the first reservoir.

19. The card of claim 18 further comprises a third reservoir containing a reagent and fluidly coupled to the reaction chamber, wherein the third reservoir is connectable to the pressure source for selectively dispensing the reagent from the third reservoir after dispensing the liquid sample from the first reservoir and before dispensing the neutralizing agent from the second reservoir.

20. The card of claim 18, wherein the third reservoir is further fluidly coupled to the second reservoir.

21. The card of claim 17, wherein the liquid is selected form the group consisting of a sample, a reagent, and a biological fluid.

22. A micro-fluidic device comprising:
means for containing a neutralizing agent formed in a substrate of the micro-fluidic device;
means for receiving and containing a liquid formed in a substrate of the micro-fluidic device; and
means for directing the neutralizing agent from the neutralizing agent containing means through the sample receiving and containing means after the liquid has been dispensed.

23. A method of neutralizing a micro-fluidic device, comprising:
directing a neutralizing agent from a first reservoir formed in a substrate of the micro-fluidic device through a second reservoir formed in the substrate after contents of the second reservoir have been dispensed from the second reservoir.

24. The method of claim 23, wherein the contents of the second reservoir are a sample or a reagent.

25. The method of claim 23 further comprises directing the neutralizing agent from the second reservoir through a reaction chamber formed in the substrate.

26. The method of claim 25 further comprises directing the neutralizing agent from the reaction chamber to a waste reservoir formed in the substrate.

27. The method of claim 23, wherein directing the neutralizing agent from the first reservoir is in response to rotating the micro-fluidic device at a predetermined rotational velocity.

28. The method of claim 23, wherein directing the neutralizing agent from the first reservoir is in response to selectively pressurizing the first reservoir.

29. The method of claim 23 further comprises removing a temporary seal from the first reservoir before directing the neutralizing agent from the first reservoir.

30. The method of claim 23, wherein the neutralizing agent disinfects a biohazard waste.

31. A method of performing a chemical assay using a micro-fluidic device, comprising:
directing a liquid sample from a sample reservoir formed in a substrate of the micro-fluidic device to a reaction chamber formed in the substrate;
directing a reagent to the reaction chamber from a reagent reservoir formed in the substrate;
reacting the liquid sample with the reagent in the reaction chamber;
detecting the reacted sample and reagent in the reaction chamber; and
after detecting the reacted sample and reagent, directing a neutralizing agent from a neutralizing agent reservoir formed in the substrate through the sample reservoir, through the reaction chamber, and into a waste reservoir formed in the substrate.

32. The method of claim 31, wherein directing the liquid sample from the sample reservoir to the reaction chamber is in response to rotating the micro-fluidic device at a first rotational velocity, wherein directing the reagent to the reaction chamber from the reagent reservoir is in response to rotating the micro-fluidic device at a second rotational velocity different from the first rotational velocity, and wherein directing the neutralizing agent from the neutralizing agent reservoir through the sample reservoir, through the reaction chamber, and into the waste reservoir is in response to rotating the micro-fluidic device at a third rotational velocity different from the first and second rotational velocities.

33. The method of claim 31, wherein directing the liquid sample from the sample reservoir to the reaction chamber is in response to selectively pressurizing the sample reservoir, wherein directing the reagent to the reaction chamber from the reagent reservoir is in response to selectively pressurizing the reagent reservoir after pressurizing the sample reservoir, and wherein directing the neutralizing agent from the neutralizing agent reservoir through the sample reservoir, through the reaction chamber, and into the waste reservoir is in response to selectively pressurizing the neutralizing agent reservoir after pressurizing the chromophore reservoir.

34. The method of claim 31 further comprises removing a temporary seal from the neutralizing agent reservoir before directing the neutralizing agent from the neutralizing agent reservoir.

35. The method of claim 31 further comprises directing the neutralizing agent through the reagent reservoir after directing the reagent to the reaction chamber.

36. A method of forming a micro-fluidic device, comprising:
forming a first reservoir in a substrate for receiving and containing a liquid sample a reagent or both;
forming a second reservoir in the substrate for containing a neutralizing agent;
forming a micro-fluidic channel in the substrate that fluidly couples the first and second reservoirs; and
filling the second reservoir with the neutralizing agent.

37. The method of claim 36, wherein forming the micro-fluidic channel in the substrate further comprises forming a micro-fluidic valve in the micro-fluidic channel.

38. The method of claim 36, wherein the the micro-fluidic device is a rotatable medium a lateral flow device, a selectively pressurized dispensing device, or combinations thereof.

39. The method of claim 36 further comprises forming a reaction chamber in the substrate and fluidly coupling the reaction chamber to the first reservoir and to the second reservoir through the first reservoir.

40. The method of claim 39 further comprises forming a third reservoir in the substrate and fluidly coupling the third reservoir to the reaction chamber and the second reservoir.

41. The method of claim 36 further comprises temporarily sealing an inlet or outlet of the second reservoir, or both, before filling the second reservoir with neutralizing agent.
